(19) United States
(12) Patent Application Publication
(10) Pub. No.: US 2025/0164383 A1
(43) Pub. Date: May 22, 2025

(54) METHOD OF MEASURING A PEEL STRENGTH BETWEEN A CARRIER TAPE AND A COVER TAPE AND APPARATUS FOR PERFORMING THE SAME

(71) Applicant: Samsung Electronics Co., Ltd., Suwon-si (KR)

(72) Inventors: Jangkun LIM, Suwon-si (KR); Joonseob SONG, Daejeon (KR)

(73) Assignees: Samsung Electronics Co., Ltd., Suwon-si (KR); INNOBIZ Co.,Ltd, Ansan-si (KR)

(21) Appl. No.: 18/660,548

(22) Filed: May 10, 2024

(30) Foreign Application Priority Data
Nov. 20, 2023 (KR) 10-2023-0160253

(51) Int. Cl. G01N 19/04; G06T 7/62

(52) U.S. Cl. CPC G01N 19/04; G06T 7/62; G06T 2200/04; G06T 2207/20072; G06T 2207/30148

(57) ABSTRACT

In a method of measuring peel strengths of adhesion portions between a carrier tape and a cover tape, the carrier tape may include a plurality of pockets configured to receive a plurality of semiconductor packages. A three-dimensional (3D) image of the adhesion portions may be obtained and volumes of the adhesion portions may be determined from the 3D image. The volumes of the adhesion portions may be converted into the peel strengths for the adhesion portions. Thus, it may not be required to form an additional sample so that the expensive sample may not be wasted. Further, the measurement of the peel strength may be performed in packing the semiconductor package so that a packing process may be continuously performed to improve a productivity of the semiconductor packaging.

### CROSS-RELATED APPLICATION

This application claims priority under 35 USC § 119 to Korean Patent Application No. 10-2023-0160253, filed on Nov. 20, 2023 in the Korean Intellectual Property Office (KIPO), the contents of which are herein incorporated by reference in their entirety.

### BACKGROUND

### 1. Field

Example embodiments relate to a method of measuring a peel strength between a carrier tape and a cover tape and an apparatus for performing the same. More particularly, example embodiments relate to a method of measuring a peel strength between a carrier tape, which may include a pocket configured to receive a semiconductor package, and a cover tape, which may be attached to the carrier tape to cover the pocket, and an apparatus for performing the method.

### 2. Description of the Related Art

Generally, a semiconductor package may be packed by a carrier tape. The carrier tape may include a pocket configured to receive the semiconductor package. A cover tape may be thermally attached to the carrier tape to cover the pocket.

In order to measure a peel strength between the carrier tape and the cover tape, a part of the carrier tape and the cover tape, attached to each other, may be cut to form a sample, and a peel strength of the sample may be measured using a measurer.

However, this way of measuring the peel strength typically require the formation of the sample by cutting the carrier tape and the cover tape. Further, the sample, after measuring the peel strength, may be scrapped so that the sample may be wasted. Additionally, a worker may measure the peel strength using the measurer so that an error may be generated at a measured peel strength.

### SUMMARY

Example embodiments provide a method of accurately measuring a peel strength between a carrier tape and a cover tape without a sample.

Example embodiments also provide an apparatus for performing the above-mentioned method.

According to some example embodiments, there may be provided a method of measuring peel strengths of adhesion portions between a carrier tape and a cover tape. The carrier tape may include a plurality of pockets configured to receive a plurality of semiconductor packages. The cover tape may be configured to cover the pockets. A three-dimensional (3D) image of the adhesion portions may be obtained. Volumes of the adhesion portions may be determined from the 3D image of the adhesion portions. The volumes of the adhesion portions may be converted into the peel strengths for the adhesion portions.

According to some example embodiments, there may be provided a method of measuring peel strengths of adhesion portions between a carrier tape and a cover tape. The carrier tape may include a plurality of pockets configured to receive a plurality of semiconductor packages. The cover tape may be configured to cover the pockets. The adhesion portions may be photographed while being illuminating to obtain a three-dimensional (3D) image of the adhesion portions. Volumes of first adhesion portions, which may be positioned at sides of each of the pockets, among the adhesion portions may be calculated from the 3D image. A volume of a second adhesion portion, which may be positioned between the pockets to connect the first adhesion portions with each other, may be calculated from the 3D image. The volumes of the first adhesion portions and the volume of the second adhesion portion may be converted into a peel strength by the first adhesion portions and a peel strength by the second adhesion portion.

According to some example embodiments, there may be provided an apparatus for measuring peel strengths of adhesion portions between a carrier tape and a cover tape. The carrier tape may include a plurality of pockets configured to receive a plurality of semiconductor packages. The cover tape may be configured to cover the pockets. The apparatus may include an image obtainer and processing circuitry. The image obtainer may obtain a three-dimensional (3D) image of the adhesion portions. The processing circuitry may calculate volumes of the adhesion portions from the 3D image of the adhesion portions and may convert the volumes of the adhesion portions into the peel strengths by the adhesion portions.

According to some example embodiments, the volumes of the adhesion portions between the carrier tape and the cover tape may be calculated by a non-contact manner. The peel strength between the carrier tape and the cover tape may be accurately measured from the volumes of the adhesion portions. Thus, it may not be required to form an additional sample so that the expensive sample may not be wasted. Particularly, the volumes of the adhesion portions may be converted into the peel strength using a conversion graph to obtain the accurate peel strengths of the adhesion portions. Further, the measurement of the peel strength may be performed in packing the semiconductor package so that a packing process may be continuously performed to improve a productivity of the semiconductor packaging.

### BRIEF DESCRIPTION OF THE DRAWINGS

Example embodiments will be more clearly understood from the following detailed description taken in conjunction with the accompanying drawings. FIGS. 1 to 11 represent non-limiting, example embodiments as described herein.

FIG. 1 is a plan view illustrating adhesion portions between a carrier tape and a cover tape;

FIG. 2 is a cross-sectional view taken along a line A-A′ in FIG. 1;

FIG. 3 is a view illustrating an apparatus for measuring a peel strength between a carrier tape and a cover tape in accordance with example embodiments;

FIG. 4 is an image showing adhesion portion between the carrier tape and a cover tape obtained using the apparatus in FIG. 3;

FIG. 5 is a view illustrating a process for measuring a volume of a first adhesion portion using the apparatus in FIG. 3;

FIG. 6 is a view illustrating a process for measuring a volume of a second adhesion portion using the apparatus in FIG. 3;

FIG. 7 is a view illustrating a length of an adhesion portion in an X-direction using the apparatus in FIG. 3;

FIG. 8 is a view illustrating lengths of an adhesion portion in a Y-direction and a Z-direction using the apparatus in FIG. 3;

FIG. 9 is a conversion graph used for converting a volume of an adhesion portion obtained using the apparatus in FIG. 3 into a peel strength;

FIG. 10 is a view illustrating a peel strength measured by the apparatus in FIG. 3; and

FIG. 11 is a flow chart illustrating a method of measuring a peel strength between a carrier tape and a cover tape using the apparatus in FIG. 3.

### DETAILED DESCRIPTION OF THE EMBODIMENTS

Hereinafter, example embodiments will be explained in detail with reference to the accompanying drawings.

In the following, functional units, including units that process at least one function or operation, may be implemented in processing circuitry such as hardware, software, and/or a combination of hardware and software. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc., and/or electronic circuits including said components.

Further, when the terms “about” or “substantially” are used in this specification in connection with a numerical value and/or geometric terms, it is intended that the associated numerical value includes a manufacturing tolerance (e.g., ±10%) around the stated numerical value. Further, regardless of whether numerical values and/or geometric terms are modified as “about” or “substantially,” it will be understood that these values should be construed as including a manufacturing or operational tolerance (e.g., ±10%) around the stated numerical values and/or geometry.

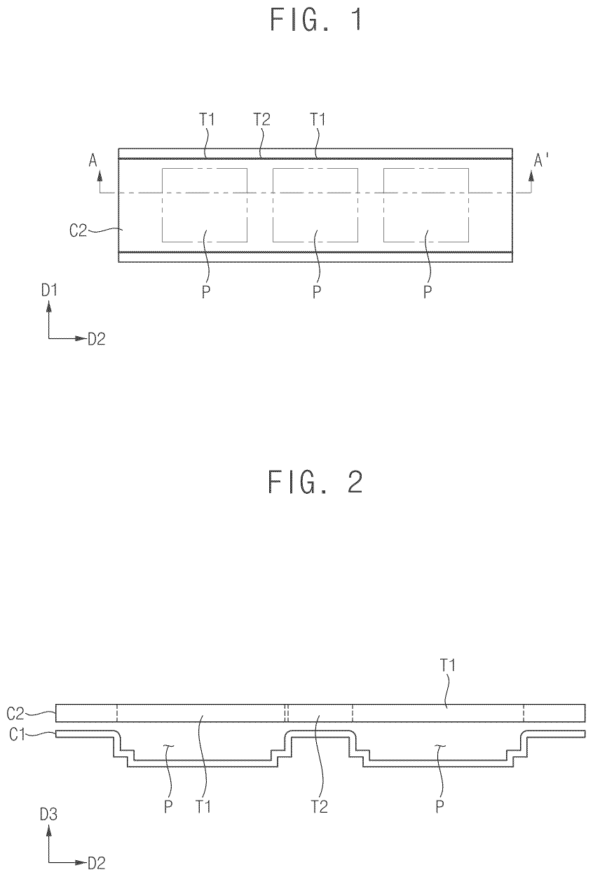

FIG. 1 is a plan view illustrating adhesion portions between a carrier tape and a cover tape and FIG. 2 is a cross-sectional view taken along a line A-A′ in FIG. 1.

Referring to FIGS. 1 and 2, a plurality of semiconductor packages may be packed using a carrier tape C1 and a cover tape C2. Particularly, the carrier tape C1 may include a plurality of pockets P. The pockets P may be arranged spaced apart from each other by a uniform gap along a second horizontal direction D2, e.g., a Y-direction. The cover tape C2 may be attached to the carrier tape C1 to cover the pockets P. Both edge portions of an upper surface of the carrier tape C1 and both edge portions of a lower surface of the cover tape C2 positioned at both sides of the pockets P may be attached to each other. Thus, the both edge portions of the carrier tape C1 and the cover tape C2 may correspond to adhesion portions of the carrier tape C1 and the cover tape C2. That is, each of the adhesion portions may have a stack structure where the carrier tape C1 and the cover tape C2 may be stacked in a vertical direction D3, e.g., a Z-direction. As a result, the adhesion portions may be a pair of the adhesion portions extended from both sides of the pockets P along the second horizontal direction D2.

Because the adhesion portions may be at the both sides of the pockets P, the adhesion portions may be extended in the second horizontal direction D2. The adhesion portions may include a plurality of first adhesion portions T1 and a plurality of second adhesion portions T2. The first adhesion portions T1 may be positioned at both of the sides of each of the pockets P. The second adhesion portions T2 may be between the first adhesion portions T1. The pocket P may be positioned between the first adhesion portions T1 along the second horizontal direction D2, e.g., the Y-direction. Because the second adhesion portions T2 may be positioned between the first adhesion portions T1, the second adhesion portions T2 may be positioned between the pockets P along the second horizontal direction D2.

Bond strengths of the adhesion portions, e.g., peel strengths of the adhesion portions may determine a packing error of the semiconductor package. For example, when the peel strengths of the adhesion portions are weak, the cover tape C2 may be detached from the carrier tape C1. Thus, the semiconductor package may be released from the pocket P. Therefore, it may be important to accurately measure the peel strengths of the adhesion portions. Particularly, it may be very important to accurately measure the peel strengths of the first adhesion portions T1 at the both sides of the pockets P.

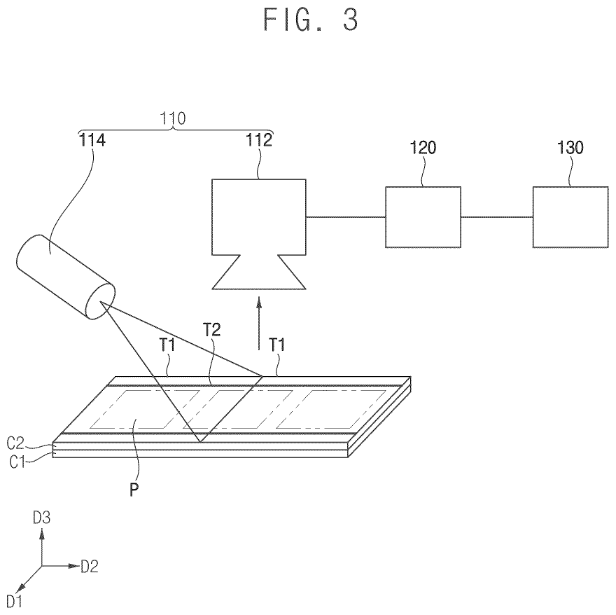

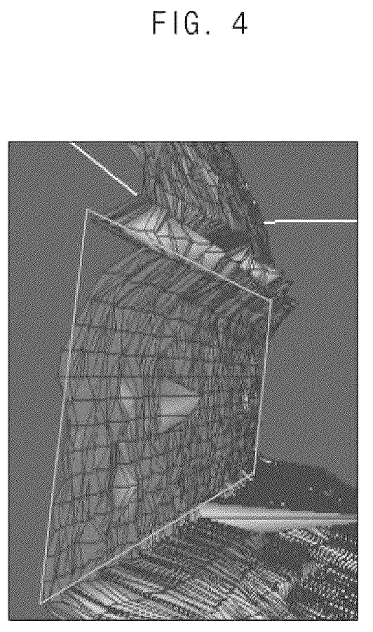

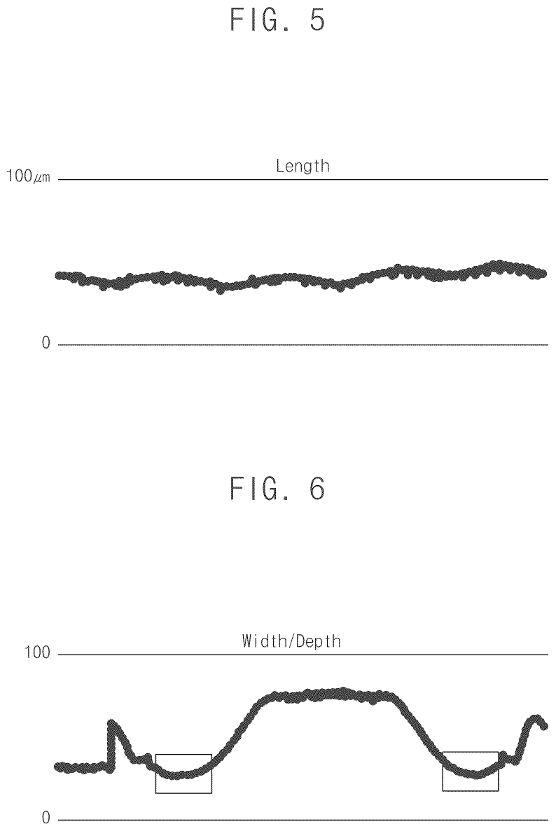

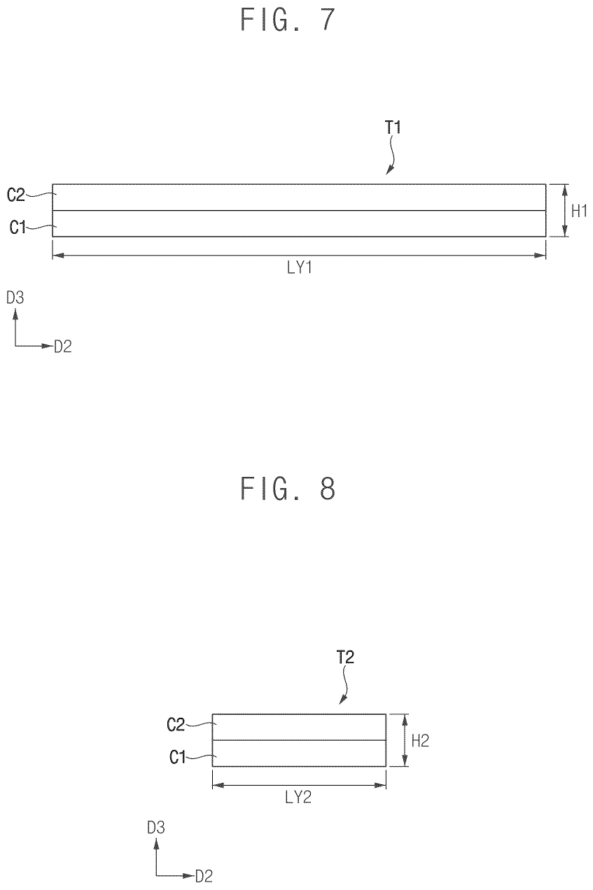

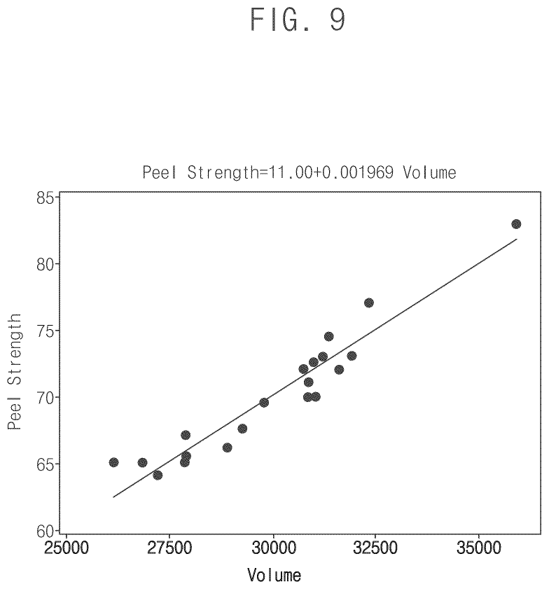

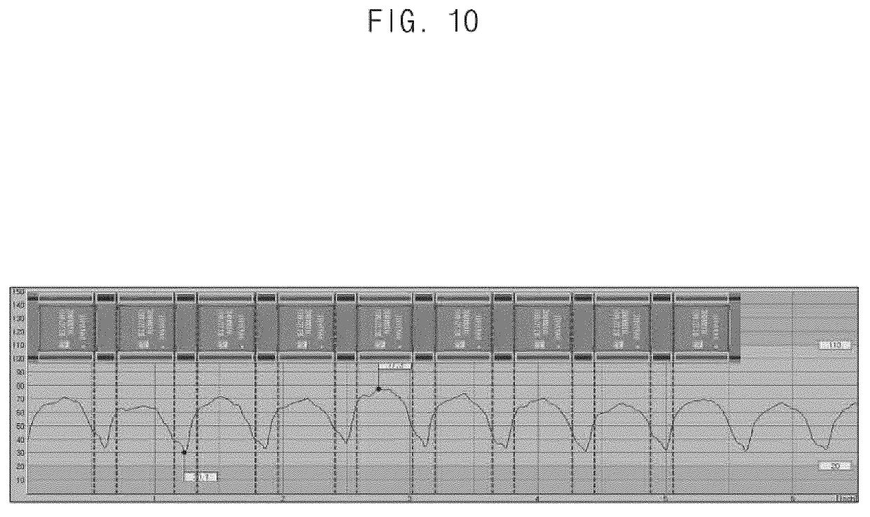

FIG. 3 is a view illustrating an apparatus for measuring a peel strength between a carrier tape and a cover tape in accordance with example embodiments, FIG. 4 is an image showing adhesion portion between the carrier tape and a cover tape obtained using the apparatus in FIG. 3, FIG. 5 is a view illustrating a process for measuring a volume of a first adhesion portion using the apparatus in FIG. 3, FIG. 6 is a view illustrating a process for measuring a volume of a second adhesion portion using the apparatus in FIG. 3, FIG. 7 is a view illustrating a length of an adhesion portion in an X-direction using the apparatus in FIG. 3, FIG. 8 is a view illustrating lengths of an adhesion portion in a Y-direction and a Z-direction using the apparatus in FIG. 3, FIG. 9 is a conversion graph used for converting a volume of an adhesion portion obtained using the apparatus in FIG. 3 into a peel strength and FIG. 10 is a view illustrating a peel strength measured by the apparatus in FIG. 3.

Referring to FIG. 3, an apparatus for measuring the peel strength between the carrier tape C1 and the cover tape C2 may include an image obtainer 110, a calculator 120, and a converter 130. The apparatus is configured to measure the peel strengths of the adhesion portions in a non-contact manner. Thus, it may not be required to form a sample of the adhesion portion. Further, the apparatus may measure the peel strengths of the adhesion portions in packing the semiconductor package in real time.

The image obtainer 110 may obtain a three-dimensional (3D) image of the adhesion portions. In some example embodiments, the image obtainer 110 may include a camera 112 and an illuminator 114. The camera 112 may be arranged over the adhesion portions. For example, the camera 112 may be on a gimble and the adhesion portion positioned under the camera 112, and/or the camera 112 may be positioned over the adhesion portion. The camera 112 is configured to photograph the adhesion portions to obtain a 3D image, e.g., as illustrated in FIG. 4. In order to obtain the clear 3D image, the illuminator 114 may illuminate the adhesion portions using a line laser.

The calculator 120 may calculate volumes of the adhesion portions from the 3D image obtained by the image obtainer 110. As mentioned above, because the adhesion portions may include the first adhesion portions T1 and the second adhesion portions T2, the calculator 120 may individually calculate volumes of the first adhesion portions T1 and volumes of the second adhesion portions T2.

For example, as shown in FIG. 5, the calculator 120 may measure a first horizontal length of the first adhesion portion T1 along a first horizontal direction D1, e.g., an X-direction, a second horizontal length LY1 of the first adhesion portion T1 along the second horizontal direction D2, and a vertical length H1 of the first adhesion portion T1 along the vertical direction D3. The calculator 120 may multiply the first horizontal length, the second horizontal length LY1 and the vertical length H1 to obtain the volume of the first adhesion portion T1. The first horizontal direction D1 may be, for example, a direction in the same plane as and substantially perpendicular to the second horizontal direction D2.

Further, as shown in FIG. 6, the calculator 120 may measure a first horizontal length of the second adhesion portion T2 along the first horizontal direction D1, a second horizontal length LY2 of the second adhesion portion T2 along the second horizontal direction D2, and a vertical length H2 of the second adhesion portion T2 along the vertical direction D3. The calculator 120 may multiply the first horizontal length, the second horizontal length LY2 and the vertical length H2 to obtain the volume of the second adhesion portion T2.

In some example embodiments, the first horizontal length of the first adhesion portion T1 along the first horizontal direction D1 may be the same as and/or substantially similar to the first horizontal length of the second adhesion portion T2 along the first horizontal direction D1. Further, as shown in FIGS. 1 and 7-8, the vertical length H1 of the first adhesion portion T1 along the vertical direction D3 may be the same as and/or substantially similar to the vertical length T2 of the second adhesion portion T2 along the vertical direction D3. In contrast, the length of the pocket P along the second horizontal direction D2 may be longer than a gap between the pockets P along the second horizontal direction D2. Thus, the second horizontal length LY1 of the first adhesion portion T1 along the second horizontal direction D2 may be longer than the second horizontal length LY2 of the second adhesion portion T2 along the second horizontal direction D2. As a result, ratios of the second horizontal lengths with respect to the vertical length may be differently shown at the first adhesion portion T1 and the second adhesion portion T2. Therefore, the volume of the first adhesion portion T1 may be larger than the volume of the second adhesion portion T2.

The converter 130 may convert the volumes of the adhesion portions calculated by the calculator 120 into the peel strengths. Particularly, the converter 130 may convert the volumes of the adhesion portions into the peel strengths using a conversion graph, e.g., as illustrated in FIG. 9. The conversion graph may show a relation between the volumes of the adhesion portions and the peel strengths. The relation between the volumes of the adhesion portions and the peel strengths may be shown as the conversion graph in FIG. 9 by measuring the volumes of the adhesion portions, measuring actual peel strengths of the adhesion portions, and matching the volumes of the adhesion portions with the peel strengths.

In at least some example embodiments, the apparatus for measuring the peel strength between the carrier tape C1 and the cover tape C2 may be included in a packaging apparatus, and may identify areas of the adhesion portions to undergo further processing. For example, in at least some example embodiments, when the converter 130 identifies that the peel strength of the adhesion portions of an area is lower than a threshold value, the area may be identified as to be subject to additional processing, such as the application of additional pressures between the carrier tape C1 and the cover cape C2 in the area, heat sealing, removal from production, and/or the like. In at least some embodiments, the additional processing may be performed based on a degree of the peel strength. For example, the magnitude of the peel strength may be used to identify a corrective measure and the corrective measure performed without human intervention; thereby reducing the potential for human error, and/or reducing the cost of production.

FIG. 10 is a view illustrating a peel strength measured by the apparatus in FIG. 3. As shown in FIG. 10, because the volume of the first adhesion portion T1 may be larger than the volume of the second adhesion portion T2, it can be noted that the peel strength of the first adhesion portion T1 may be higher than the peel strength of the second adhesion portion T2.

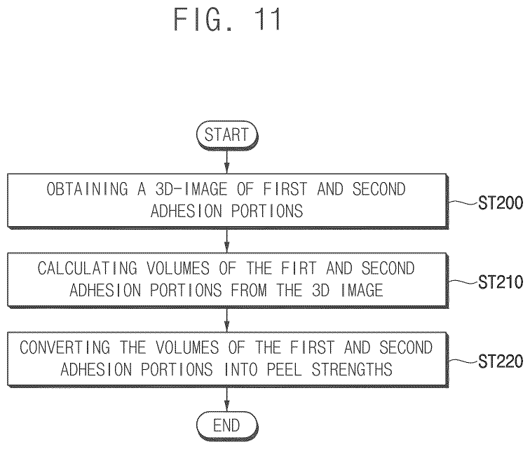

FIG. 11 is a flow chart illustrating a method of measuring a peel strength between a carrier tape and a cover tape using the apparatus in FIG. 3.

Referring to FIGS. 3 and 11, in operation ST200, the image obtainer 110 obtains the 3D image of the adhesion portions. Particularly, the camera 112 may photograph the adhesion portions to obtain the 3D image and the illuminator 114 may illuminate the adhesion portions using the line laser.

In step ST210, the calculator 120 may calculate the volumes of the adhesion portions. In example embodiments, the calculator 120 may individually calculate the volumes of the first adhesion portions T1 and the volumes of the second adhesion portions T2.

Particularly, the calculator 120 may measure the first horizontal length of the first adhesion portion T1 along the first horizontal direction D1, the second horizontal length LY1 of the first adhesion portion T1 along the second horizontal direction D2, and the vertical length H1 of the first adhesion portion T1 along the vertical direction D3. The calculator 120 may multiply the first horizontal length, the second horizontal length LY1 and the vertical length H1 to obtain the volume of the first adhesion portion T1.

Further, the calculator 120 may measure the first horizontal length of the second adhesion portion T2 along the first horizontal direction D1, the second horizontal length LY2 of the second adhesion portion T2 along the second horizontal direction D2, and the vertical length H2 of the second adhesion portion T2 along the vertical direction D3. The calculator 120 may multiply the first horizontal length, the second horizontal length LY2 and the vertical length H2 to obtain the volume of the second adhesion portion T2.

In step ST220, the converter 130 may convert the volumes of the adhesion portions into the peel strengths. Particularly, the converter 130 may convert the volumes of the adhesion portions into the peel strengths using the conversion graph. In example embodiments, the converter 130 may convert the volume of the first adhesion portion T1 into the peel strength. The converter 130 may convert the volume of the second adhesion portion T2 into the peel strength.

According to some example embodiments, the volumes of the adhesion portions between the carrier tape and the cover tape may be calculated by the non-contact manner. The peel strength between the carrier tape and the cover tape may be accurately measured from the volumes of the adhesion portions. Thus, it may not be required to form an additional sample so that the expensive sample may not be wasted. Particularly, the volumes of the adhesion portions may be converted into the peel strength using a conversion graph to obtain the accurate peel strengths of the adhesion portions. Further, the measurement of the peel strength may be performed in packing the semiconductor package so that a packing process may be continuously performed to improve a productivity of the semiconductor packaging.

The foregoing is illustrative of example embodiments and is not to be construed as limiting thereof. Although a few example embodiments have been described, those skilled in the art will readily appreciate that many modifications are possible in the example embodiments without droplet departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of measuring peel strengths of adhesion portions between a carrier tape and a cover tape, the carrier tape including a plurality of pockets configured to receive semiconductor packages, the cover tape configured to cover the pockets, the method comprising:
obtaining a three-dimensional (3D) image of the adhesion portions;
determining volumes of the adhesion portions from the 3D image of the adhesion portions; and
converting the volumes of the adhesion portions into the peel strengths for the adhesion portions.

2. The method of claim 1, wherein the obtaining the 3D image of the adhesion portions comprises photographing the adhesion portions using a camera.

3. The method of claim 2, wherein the obtaining the 3D image of the adhesion portions further comprises illuminating the adhesion portions using a line laser.

4. The method of claim 1, wherein the adhesion portions comprise a pair of the adhesion portions extended from both sides of each of the pockets along a first horizontal direction.

5. The method of claim 4, wherein the determining the volumes of the adhesion portions comprises measuring a first horizontal length of each of the adhesion portions along the first horizontal direction, a second horizontal length of each of the adhesion portions along a second horizontal direction substantially perpendicular to the first horizontal direction, and a vertical length of each of the adhesion portions along a vertical direction.

6. The method of claim 1, wherein the measuring the volumes of the adhesion portions comprises:
determining volumes for first adhesion portions at sides of each of the pockets, and
determining a volume of a second adhesion portion between the pockets, the second adhesion portion connecting the first adhesion portions with each other.

7. The method of claim 6, wherein the converting the volumes of the adhesion portions into the peel strengths comprises:
converting the volumes of the first adhesion portions into a first peel strength for each of the first adhesion portions; and
converting the volume of the second adhesion portion into a second peel strength of the second adhesion portion.

8. The method of claim 1, wherein converting the volumes of the adhesion portions into the peel strengths comprises using a conversion graph showing a relation between the volumes and the peel strengths of the adhesion portions.

9. A method of measuring peel strengths of adhesion portions between a carrier tape and a cover tape, the carrier tape including a plurality of pockets configured to receive semiconductor packages, the cover tape configured to cover the pockets, the method comprising:
obtaining a three-dimensional (3D) image of the adhesion portions using a camera to photograph the adhesion portions and a line laser to illuminate the adhesion portion;
determining volumes of first adhesion portions, among the adhesion portions from the 3D image, which are positioned at sides of each of the pockets, from the 3D image;
determining a volume of a second adhesion portion, among the adhesion portions from the 3D image which are positioned between the pockets and connect the first adhesion portions with each other, from the 3D image; and
converting the volumes of the first adhesion portions and the volume of the second adhesion portion into peel strengths of the first adhesion portions and a peel strength of the second adhesion portion, respectively.

10. The method of claim 9, wherein the adhesion portions comprise a pair of the adhesion portions extended from both sides of each of the pockets along a first horizontal direction.

11. The method of claim 10, wherein the determining the volumes of the first adhesion portions and the volume of the second adhesion portion comprises measuring a first horizontal length of each of the first and second adhesion portions along the first horizontal direction, a second horizontal length of each of the first and second adhesion portions along a second horizontal direction substantially perpendicular to the first horizontal direction and a vertical length of each of the first and second adhesion portions along a vertical direction.

12. The method of claim 9, wherein the converting the volumes of the first adhesion portions and the volume of the second adhesion portion into the peel strengths of the first adhesion portions and the peel strength of the second adhesion portion comprises using a conversion graph showing a relation between the volumes and the peel strengths of the first and second adhesion portions.

13. An apparatus configured to measure peel strengths of adhesion portions between a carrier tape and a cover tape, the carrier tape including a plurality of pockets configured to receive semiconductor packages, the cover tape configured to cover the pockets, the apparatus comprising:
an image obtainer configured to obtain a three-dimensional (3D) image of the adhesion portions; and
processing circuitry configured to
calculate volumes of the adhesion portions from the 3D image of the adhesion portions, and
convert the volumes of the adhesion portions into the peel strengths.

14. The apparatus of claim 13, wherein the image obtainer comprises a camera configured to photograph the adhesion portions.

15. The apparatus of claim 14, wherein the image obtainer further comprises illuminator configured to illuminate the adhesion portions using a line laser.

16. The apparatus of claim 13, wherein the adhesion portions comprise a pair of the adhesion portions extended from both sides of each of the pockets along a first horizontal direction.

17. The apparatus of claim 16, wherein the processing circuitry is configured to measure a first horizontal length of each of the adhesion portions along the first horizontal direction, a second horizontal length of each of the adhesion portions along a second horizontal direction substantially perpendicular to the first horizontal direction and a vertical length of each of the adhesion portions along a vertical direction.

18. The apparatus of claim 13, wherein the processing circuitry is configured to measure volumes of first adhesion portions sides of each of the pockets and a volume of a second adhesion portion between the pockets and connecting the first adhesion portions with each other.

19. The apparatus of claim 18, wherein the processing circuitry is configured to convert the volume of each of the first adhesion portion into a peel strength for the first adhesion portion and the volume of the second adhesion portion into a peel strength for the second adhesion portion.

20. The apparatus of claim 13, wherein the processing circuitry is configured to use a conversion graph showing a relation between the volumes and the peel strengths of the adhesion portions to convert the volumes of the adhesion portions into the peel strengths.
